(19) United States
(12) Patent Application Publication
(10) Pub. No.: US 2018/0196973 A1
(43) Pub. Date: Jul. 12, 2018

(54) Security Certification Method for Hiding Ultra-High Frequency Electronic Tag Identifier

(71) Applicant: TRAFFIC MANAGEMENT RESEARCH INSTITUTE OF THE MINISTRY OF PUBLIC SECURITY, WuXi (CN)

(72) Inventors: Zhengliang SUN, Wuxi (CN); Jin HUANG, Wuxi (CN); Gang CAI, Wuxi (CN); Dongbo LIU, Wuxi (CN); Jiabin HU, Wuxi (CN)

(73) Assignee: TRAFFIC MANAGEMENT RESEARCH INSTITUTE OF THE MINISTRY OF PUBLIC SECURITY, WuXi (CN)

(21) Appl. No.: 15/106,843

(22) PCT Filed: May 25, 2015
(86) PCT No.: PCT/CN2015/079692

§ 371 Date: Jun. 21, 2016

(30) Foreign Application Priority Data
Aug. 29, 2014 (CN) 201410439094.2

(51) Int. Cl. G06K 7/10; H04L 9/06

(52) U.S. Cl. CPC G06K 7/10257; H04L 9/0625

(57) ABSTRACT

A security certification method for hiding an ultra-high frequency electronic tag identifier. By encrypting the electronic tag identifier (TID) using a random number, and returning it in the cipher text, this certification method can effectively avoid an illegal reading/writing device from acquiring the TID information and from performing illegal tracking and identity recognition on an object identified by the electronic tag. Meanwhile, this certification method can effectively resist attacks, such as eavesdropping, counterfeiting, replaying, and etc. It has the advantages of preventing the electronic tag information from being eavesdropped and counterfeited, and etc. The security certification method uses the symmetric encryption algorithm of the national commercial cryptographic algorithm and the dual-key and the two-step certification mechanism. Thus, the certification of the validity of the electronic tag with the same-key of a batch of cards, and the bidirectional security certification with the single-tag and single-key are achieved.

### TECHNICAL FIELD

This invention relates to a certification method, especially to a security certification method for hiding an ultra-high frequency electronic tag identifier, which belongs to the technical field of ultra-high frequency identification.

### BACKGROUND

Radio-frequency identification (RFID) is a contactless automatic identification technology based on wireless communication, and is one of the six basic technologies of the Internet of Things. The RFID technology can automatically identify or read the object information without any physical contact, which makes it widely used in the automatic identification and digital management for staff, animal, object, and so on.

Passive ultra-high frequency radio-frequency identification (UHF RFID) refers to the radio-frequency identification system whose operating frequency is in the ranges of 840˜845 MHz and 920˜925 MHz. A simple electronic tag reading system is composed of three parts: the electronic tag, the reader/writer, and the antenna. The tag communicates with the reader/writer in the electromagnetic backscatter coupling manner. The tag acquires necessary working energy through electromagnetic induction, without battery.

UHF RFID wireless communication has the characteristic of broadcasting, especially, its long reading distance (5 to 20 meters). As a result, it is very vulnerable to attacks such as faking and replaying. Therefore, the significant concerns lie in the privacy protection and the information security in the RFID system application. Currently, the most common air interface protocol standard of the UHF RFID are ISO I8000-6C (6C standard for short) and National Standard GB/T29768 promulgated in 2013 in China. Wherein, the 6C standard can only protect the data of the user partition of the electronic tag b the access code. The access code of the electronic tag and the electronic tag identifier (TID) are transmitted with clear text on the air. Therefore, it is hard for the 6C standard to prevent the electronic tag data from being copied and usurped Chinese National Standard GB/T29768 adopts a safety certification and communication mechanism based on the symmetric cryptographic algorithm. Thus, its security performance has obviously increased compared with the 6C standard. However, since Chinese National Standard GB/T29768 uses the electronic tag identifier (TID) as the key distributed parameter, which needs to return the TID in clear text, the National Standard GB/T29768 still cannot provide a reading protection for the TID information. Moreover, in the field related to the vehicle application, the TID is the unique identification information of the vehicle identified by the electronic tag. It is the core information in the field related to the vehicle application. If the TID cannot be protected, there will be significant potential security risks such as the illegal reader/writer track the vehicle by reading the TID.

### SUMMARY OF THE INVENTION

The objective of this invention is to provide a security certification method for hiding an ultra-high frequency electronic tag identifier to overcome the deficiency in the prior art. This method can avoid the illegal reader/writer from tracking the vehicle by acquiring the identifier of the electronic tag, and can ensure the mutual recognition and communication between the electronic tag and the reader/writer.

According to the technical solution provided by this invention, a security certification method for hiding an ultra-high electronic tag identifier, the certification method including the following steps:

a. The reader/writer sends a certification request message to the electronic tag. Upon receiving the certification request message, the electronic tag reads the batch key BKey from the security information partition of the electronic tag and the electronic tag batch number TBN from the identification information partition of the electronic tag. The electronic tag encrypts the batch key BKey, the electronic tag batch number TBN, the random number RNt, and the electronic tag identifier TID to obtain the tag encryption identifier TID′. The electronic tag returns the tag encryption identifier TID′, the random number RNt, and the electronic tag batch number TBN as a response to the reader/writer.

b. The reader/writer receives the tag encryption identifier TID′, the random number RNt, and the electronic tag batch number TBN the electronic tag batch number TBN is encrypt-scattered using the certification root key RKey so as to obtain the reading/writing batch key BKey′. The tag encryption identifier TID′ and the random number RNt are decrypted by the reading/writing batch key BKey′ to obtain the reading writing tag decryption identifier TID″.

c. The reader/writer encrypt-scatters reading/writing tag decryption identifier TID″ using the certification root key RKey to obtain the reading/writing single-tag certification key Tkey′. The reading/writing single-tag certification key TKey′ and the random number RNt are encrypted to obtain the reading/writing access control code MAC₁. The reader/writer sends the reading/writing access control code MAC₁ to the electronic tag.

d. The electronic tag receives reading/writing access control code MAG₁, and conducts the decryption using the single-tag key TKey in the security information partition to obtain the random number RNt′. The electronic tag is compared with the random number RNt′ with random number RNt. When the random number RNt′ is not consistent with the random number RNt, the certification process between the electronic to and the reader/writer ends. Otherwise, it is proceeded to the step e.

e. The electronic tag regenerates a random number RNt″, and encrypts the random number RNt″ and the single-tag certification key TKey to obtain a tag access control code MAC₂. Then the tag access control code MAC₂ is sent to the reader/writer.

f. The reader/writer receives the tag access control code MAC₂, and decrypts the tag access control code MAC₂ using the reading/writing single-tag certification key TKey′ to obtain the random number RNr′. If the random number RNr′ is consistent with the random number RNr, the reader/writer passes the certification of the electronic tag. Otherwise, the certification fails.

In the step b, the certification root key RKey is located in the security control module PSAM of the reader/writer. The security control module PSAM encrypt-scatters the electronic tag hatch number TBN using the certification root key RKey to obtain the reading/writing batch key BKey′.

In the step a, the electronic tag encrypts the electronic tag identifier TID, the random number RNt, and the electronic tag batch key BKey to obtain electronic tag encryption identifier TID′ which is:

TID′=E1(TID⊕RNt,BKey)

wherein, E1 is the symmetric encryption operation function; and ⊕ is the Exclusive-OR (XOR) operation.

In the step b, the reading/writing, tag decryption identifier TID″ obtained by the reader/writer is:

TID″=E2(TID′,BKey)⊕RNt

wherein, E2 is the symmetric encryption operation function; and ⊕ is the XOR operation.

In the step c, reading/writing access control code MAC₁ obtained by the reader/writer is:

MAC₁=E2(RNt∥RNr, TKey′)

wherein, E2 is the symmetric encryption operation function; and ∥ refers to the information cascading operation.

In the step d, the RNt′ obtained by the electronic tag is:

{RNt′∥RNr}=E1(MAC₁,TKey)

wherein, E1 is the symmetric encryption operation function; and ∥ refers to the information cascading operation.

In the step e, the tag reading/writing access control code MAC₂ obtained by the electronic tag is:

MAC₂=E1(RNt″∥RNr,TKey)

wherein, E1 is the symmetric encryption operation function; and ∥ means the information cascading operation.

In the step f, the random number RNr′ obtained by the reader/writer is:

{RNt″∥RNr}=E2(MAC₂,TKey)

wherein, E2 is the symmetric encryption operation function; and ∥ refers to the information cascading operation.

This invention can provide a good defense against the potential security risk and the personal privacy issue in existing RFID system. Specifically, in the field related to vehicle, the advantages of this security certification method are more significant. More particularly, the advantages are as follows:

1. It has the information protecting function for the electronic tag identifier TID. In the security certification method of this invention, the information of electronic tag identifier TID and the random number are XORed and encrypted, and then returned. Therefore, for the same electronic tag, each returned value is different from others. As a result, the illegal reader/writer are avoided from tracking the tag by recording the tag responsive information.

2. It can achieve the bidirectional identity certification with the single-tag and the single-key. In the security certification method, every tag has a unique identity certification key. Even if the single tag key is acquired by the illegal manner, only the data of the single tag can be read. The data stored in other electronic tags cannot be read. Therefore, information stored in the tag can be protected from being stolen.

3. Said security certification method can adapt the field related to vehicles which requires high-speed and long-range reading. In the certification method, after the reader/writer sends the certification requirement, the electronic tag first returns the encrypted information which includes the electronic tag identifier TID. Therefore, even if the subsequent security certification steps fail, the reader/writer can obtain electronic tag identifier TID of the electronic tag. In the field related to vehicle application, an electronic tag identifier TID can uniquely correspond to a vehicle. By searching in the backstage application system, the identification information registered by the vehicle can be acquired.

### BRIEF DESCRIPTION OF THE DRAWING

FIG. 1 is a schematic diagram of the security certification system of the passive ultra-high frequency radio frequency identity system of the invention.

FIG. 2 is a flow diagram of the security certification method for hiding the ultra-high frequency electronic tag identifier of the invention.

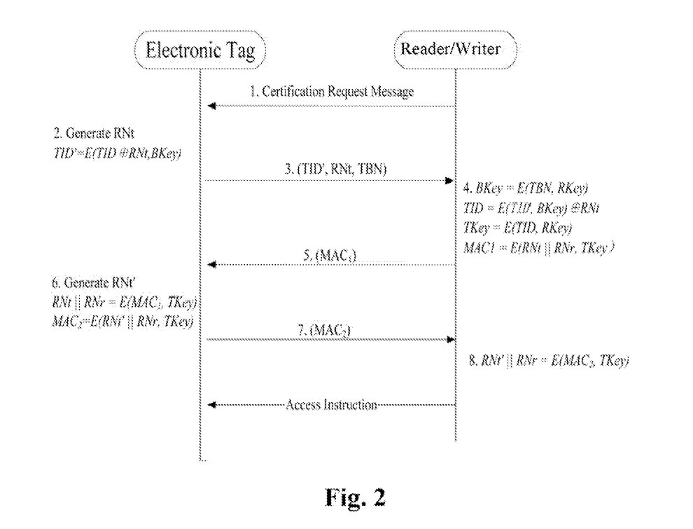

### DETAILED DESCRIPTION OF THE INVENTION

Hereinafter this invention will be further described in conjunction with the accompanying figures and embodiments.

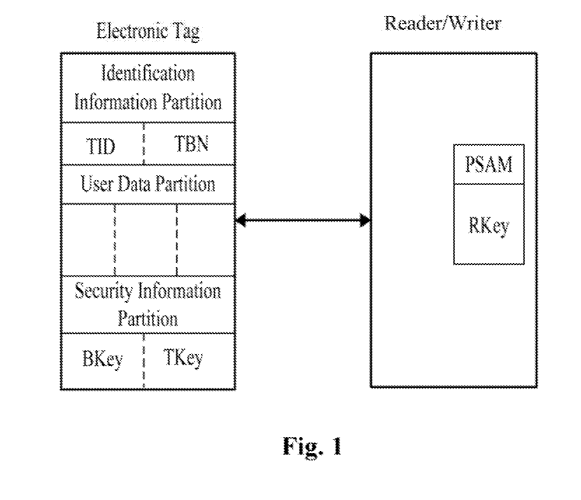

As shown in FIG. 1, which is the schematic diagram of the certification system of the passive ultra-high frequency RFID system of the invention, the system includes an electronic tag and a reader/writer.

The electronic tag includes three storage partitions: the identification information partition, the user data partition, and the security information partition. The identification information partition stores information of electronic tag identifier TID (unique serial number) and the electronic tag batch number TBN. The electronic tag identifier TID is initially written by tag-chip producing enterprises. The electronic tag batch number TBN is written by the key management center after finishing the initialization of the electronic tag. The electronic tag identifier TID and electronic tag batch number TBN cannot be changed after being written. The user data partition stores the customized information of the identified objects. Such information is written in customization in use. The security information partition stores batch key BKey and the single tag certification key TKey. The batch key BKey and the single tag certification key TKey are generated in the way that the certification root key RKey encrypts and scatters the electronic tag batch number TBN and the electronic tag identifier TID. They are synchronously written together with the information of electronic tag batch number TBN.

The built-in security control module of the reader/writer stores the information of certification root key RKey, which is written by the authorized administration.

In order to prevent the illegal reader/writer from tracking the vehicle by acquiring the electronic tag identifier, and to ensure the mutual recognition and communication between the electronic tag and the reader/writer, the certification method of this invention includes the following steps:

a. The reader/writer sends a certification request message to the electronic tag. Upon receiving the certification request message, the electronic tag reads the batch key BKey from the security information partition of the electronic tag and the electronic tag batch number TBN from the identification information partition of the electronic tag. The electronic tag encrypts batch key BKey, electronic tag batch number TBN, the random number RNt, and the electronic tag identifier TID to obtain tag encryption identifier TID′. The electronic tag returns the tag encryption identifier TID′, the random number RNt, and the electronic tag batch number TBN as the response to the reader writer.

More specifically, the electronic tag encrypts the electronic tag identifier TID, the random number RNt, and the electronic tag batch key BKey, to obtain the electronic tag encryption identifier TID′, which is:

TID′=E1(TID⊕RNt,BKey)

wherein, E1 is the symmetric encryption operation function; and ⊕ is the Exclusive-OR (XOR) operation. The random number RNt is a number generated randomly in the electronic tag.

b. The reader/waiter receives tag encryption identifier TID′, random number RNt, and electronic tag batch number TBN, the electronic tag batch number TBN is encrypted and scattered using the certification root key RKey so as to obtain the reading/writing batch key BKey′. The tag encryption identifier TID′ and the random number RNt are decrypted using read/write batch key BKey′ to obtain read write tag decryption identifier TID″.

The certification root key RKey is located inside the security control module PSAM of the reader/writer. The security control module PSAM encrypts and scatters the electronic tag batch number TBN using the certification root key RKey to obtain the read/write batch key BKey′. The formula for calculation is as follows:

BKey′=ED(TBN,RKey)

wherein, ED is the encrypt-scatter operation function.

In the step b, the read/writ tag decryption identifier TID″ obtained by the reader/writer is:

TID″=E2(TID″,BKey)⊕RNt

wherein, E2 is the symmetric encryption operation function; ⊕ is the XOR operation.

In implementation, for the authorized legal reader/writer, the encryption function E1 within the electronic tag and encryption function E2 within the reader/writer are of the predetermined encryption type. The tag encryption identifier TID′ encrypted by the electronic tag can be decrypted in the reader/writer to obtain the reading/writing tag decryption identifier TID″. The detailed executing process is well known by the person of ordinary skill in the am When the reader/writer is legal, the obtained read/write batch key BKey′ is consistent with the batch key BKey within the electronic tag. When the reader/writer is illegal, the obtained read/write batch key BKey′ is inconsistent with the batch key BKey within the electronic tag. Therefore, the obtained read/write tag decryption identifier TID″ is not the predetermined result.

c. The reader/writer encrypts and scatters the read/write tag decryption identifier TID″ using the certification root key RKey to obtain the read/write single-tag certification key TKey′, and encrypts the read/write single-tag certification key TKey′ and the random number RNt to obtain the read/write access control code MAC₁. The reader/writer sends the reading writing access control code MAC₁ to the electronic tag.

In the step c, the reading/writing access control code MAC₁ obtained by the reader/writer is:

MAC₁=E2(RNt∥RNr,TKey′)

wherein, E2 is the symmetric encryption operation function; and ∥ refers to the information cascading operation.

d. The electronic tag receives reading: writing access control code MAC₁, and conducts the decryption using the single-tag key Tkey in the security information partition to obtain the random number RNt′. The electronic tag compares the random number RNt′ with the random number RNt. When the random number RNt′ is not consistent with random number RNt, the certification process between the electronic tag and the reader/writer is ended. Otherwise, it is proceeded to the step e.

The RNt obtained by the electronic tag is:

{RNt″∥RNr}=E1(MAC₁,TKey)

wherein, E1 is the symmetric encryption operation function; and ∥ refers to the information cascading operation.

e. The electronic tag regenerates the random number RNt″, and encrypts the random number RNt″ and the single-tag certification key TKey to obtain a tag access control code MAC₂ and sends the tag access control code MAC₂ to the reader/writer.

The tag reading/writing access control code MAC₂ obtained by the electronic tag is:

MAC₂=E1(RNt″∥RNr,TKey)

wherein, E1 is the symmetric encryption operation function; and refers to the information cascading operation.

f. The reader/writer receives tag access control code MAC₂, and decrypts the tag access control code MAC₂ using the reading/writing single-tag certification key TKey′ to obtain the random number RNr′. If the random number RNr′ is consistent with the random number RNr, the reader/writer passes the certification of the electronic tag; otherwise, the certification is failed.

The random number RNr′ obtained by the reader/writer is:

{RNt″∥RNr}=E2(MAC₂,TKey)

wherein, E2 is the symmetric encryption operation function and ∥ refers to the information cascading operation.

In the embodiments of this invention, the national commercial cryptographic algorithm SM7 are used in the symmetric encryption operation function E1, E2 in steps a-f. The cryptographic algorithm of the encrypt-scatter function ED is SM1 algorithm. However, it is not limited to the SM7 algorithm for the symmetric cryptographic algorithm used in embodiments of this invention. Other symmetric cryptographic algorithm such as SM4, DES, 3DES and so on also can be used.

By encrypting the electronic tag identifier TID with the random number, and returning it in cipher text, this invention can effectively avoid the illegal reading writing device from obtaining the information of electronic tag identifier TID. As a result, the illegally tracking and the identity recognizing of the objects identified by the electronic tag can be avoided. Moreover, this certification method can effectively resist attacks such as eavesdropping, faking, and replaying. It has the advantages of preventing the electronic tag information from being stolen and counterfeited. This security certification method uses the symmetric encryption algorithm of the national commercial cryptographic algorithm, and the dual-key and the two-step certification mechanism. Thus, the certification of the validity of the electronic tag with the same-key of a batch of cards, and the bidirectional security certification with the single-tag and single-key are achieved.

1. A security certification method for hiding an ultra-high frequency electronic tag identifier, characterized in that, the certification method comprising the following steps:
(a) sending a certification request message to an electronic tag front a reader/writer, upon receiving the certification request message, the electronic tag reads a batch key BKey from a security information partition of the electronic tag and an electronic tag hatch number TBN front an identification information partition of the electronic tag; encrypting, by the electronic tag, the batch key BKey, the electronic tag batch number TBN, the random number RNt, and the electronic tag identifier TID, to obtain a tag encryption identifier TID′; returning, by the electronic tag, the tag encryption identifier TID′ the random number RNt, and the electronic tag hatch number TBN as a response and returning them to the reader/writer;
(b) receiving, by the reader/writer, the tag encryption identifier TID′ the random number RNt, and the electronic tag batch number TBN; conducting an encrypt-scatter using a certification root key RKey on the electronic tag batch number TBN to obtain a reading/writing batch key BKey′, decrypting the tag encryption identifier TID′ and the random number RNt using the reading/writing batch key BKey′ to obtain a reading/writing tag decryption identifier TID″;
(c) conducting the encrypt-scatter, by the reader/writer, on the reading/writing tag decryption identifier TID″ using the certification root key RKey to obtain a reading/writing single-tag certification key TKey′; encrypting the reading/writing single-tag certification key TKey′ and the random number RNt to obtain a reading/writing access control code MAC₁; sending, by the reader/writer, the reading/writing access control code MAC₁ to the electronic tag;
(d) receiving, by the electronic tag, the reading/writing access control code MAC₁; conducting the decryption using a single-tag key TKey in a security information partition to obtain a random number RNt′; comparing, by the electronic tag, the random number RNt′ with the random number RNt when the random number RNt″ is not consistent with the random number RNt, ending a certification process between the electronic tag and the reader/writer, otherwise, entering Step e;
(e) regenerating, by the electronic tag, a random number RNt″; encrypting the random number RNt″ and the single-tag certification key TKey to obtain a tag access control code MAC₂ and sending the tag access control code MAC₂ to the reader/writer;
(f) receiving, by the reader/writer, the tag access control code MAC decrypting the tag access control code MAC₂ using the reading/writing single-tag certification key TKey′ to obtain a random number RNr′; if the random number RNr′ is consistent with the random number RNr, passing the certification of the electronic tag by the reader/writer, otherwise, failing the certification.

2. The security certification method for hiding the ultra-high frequency electronic tag identifier according to claim 1 characterized in that in the step (b), the certification root key RKey is located in a security control module PSAM of the reader/writer; wherein the security control module PSAM encrypt-scatter the electronic tag batch number TBN using the certification root key RKey to obtain the reading/writing batch key BKey′.

3. The security certification method for hiding the ultra-high frequency electronic tag identifier according to claim 1, characterized in that: in the step (a), the electronic tag encrypts the electronic tag identifier TID, the random number RNt, and the electronic tag batch key BKey to obtain the electronic tag encryption identifier TID′ which is:
TID′=E1(TID⊕RNt,BKey)
wherein, E1 is a symmetric encryption operation function; and ⊕ is an Exclusive-OR operation.

4. The security certification method for hiding the ultra-high frequency electronic tag identifier according to claim 1, characterized in that: in the step (b), the reading/writing tag decryption identifier TID′ obtained by the reader/writer is:
TID″=E2(TID′,BKey)⊕RNt
wherein, E2 is a symmetric encryption operation function; and ⊕ is an Exclusive-OR operation.

5. The security certification method for hiding the ultra-high frequency electronic tag identifier according to claim 1, characterized in that; in the step (c), the reading/writing access control code MAC₁ obtained by the reader/writer is:
MAC₁=E2(RNt∥RNr,TKey′)
wherein, E2 is a symmetric encryption operation function; and ∥ refers to an information cascading operation.

6. The security certification method for hiding the ultra-high frequency electronic tag identifier according to claim 1 characterized in that; in the step (d), the random number RNt′ obtained by the electronic tag is:
{RNt″∥RNr}=E1(MAC₁,TKey)
wherein, E1 is a symmetric encryption operation function; and ∥ refers to an information cascading operation.

7. The security certification method for hiding the ultra-high frequency electronic tag identifier according to claim 1, characterized in that: in the step (e), the tag reading/writing access control code MAC₂ obtained by the electronic tag is:
MAC₂=E1(RNt″∥RNr,TKey)
wherein, E1 is a symmetric encryption operation function; and ∥ refers to an information cascading operation.

8. The security certification method for hiding the ultra-high frequency electronic tag identifier according to claim 1, characterized in that: in the step (f), the random number RNr′ obtained by the reader/writer is:
{RNt″∥RNr}=E2(MAC₂,TKey)
wherein, E2 is a symmetric encryption operation function, and ∥ refers to an information cascading operation.
